(19) United States
(12) Patent Application Publication
(10) Pub. No.: US 2026/0237690 A1
(43) Pub. Date: Aug. 13, 2026

(54) SEPARATOR

(71) Applicant: SUBARU CORPORATION, Tokyo (JP)

(72) Inventors: Aiko HIRAWAKI, Tokyo (JP); Michita YANAGITA, Tokyo (JP)

(73) Assignee: SUBARU CORPORATION, Tokyo (JP)

(21) Appl. No.: 19/532,765

(22) Filed: Feb. 6, 2026

(30) Foreign Application Priority Data
Feb. 10, 2025 (JP) 2025-019788

(51) Int. Cl. H01M 8/026; H01M 8/0254; B60L 50/72

(52) U.S. Cl. CPC H01M 8/026; H01M 8/0254; B60L 50/72; H01M 2250/20

(57) ABSTRACT

A separator includes a flow path at least includes a first flow path and a second flow path that are adjacent to each other. The flow path includes at least two first sections and a second section. The at least two first sections each includes a pressure loss applier configured to apply a pressure loss to a reactant gas in one or both of the first flow path and the second flow path. The second section is interposed between the at least two first sections. The pressure loss applier is configured to reverse a magnitude relationship between a pressure in the first flow path and a pressure in the second flow path before and after the reactant gas passes through the first section.

### CROSS-REFERENCE TO RELATED APPLICATIONS

The present application claims priority from Japanese Patent Application No. 2025-019788 filed on February 10, 2025, the entire contents of which are hereby incorporated by reference.

### BACKGROUND OF THE INVENTION

### Field of the Invention

The disclosure relates to a separator.

### Description of Background Art

For example, Japanese Unexamined Patent Application Publication (JP-A) No. 2021-163663 and JP-A No. 2021-163663 describes gas flow path structures. The entire contents of these publication are incorporated herein by reference.

### SUMMARY OF THE INVENTION

An aspect of the disclosure provides a separator includes a flow path at least including a first flow path and a second flow path that are adjacent to each other. The flow path includes at least two first sections and a second section. The at least two first sections each includes a pressure loss applier configured to apply a pressure loss to a reactant gas in one or both of the first flow path and the second flow path. The second section is interposed between the at least two first sections. The pressure loss applier is configured to reverse a magnitude relationship between a pressure in the first flow path and a pressure in the second flow path before and after the reactant gas passes through the first section.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view of a vehicle in which fuel cells each according to an embodiment of the disclosure is mounted;

FIG. 2 is an exploded perspective view of the fuel cell according to the embodiment of the disclosure;

FIG. 3 is a cross-sectional view of the fuel cell according to the embodiment of the disclosure;

FIG. 4 is a plan view of a separator according to an embodiment of the disclosure;

FIG. 5 is a schematic view illustrating underflow of a cathode gas in the fuel cell;

FIG. 6 is a plan view of a flow path shape according to a comparative example;

FIG. 7 is a graph illustrating flow path pressure according to a comparative example;

FIG. 8 is a graph illustrating oxygen partial pressure (solid line) and pressure difference between flow paths (broken line) according to the comparative example;

FIG. 9 is a plan view of a flow path shape according to an first embodiment of the disclosure;

FIG. 10 is a graph illustrating flow path pressure according to the embodiment of the disclosure;

FIG. 11 is a graph illustrating oxygen partial pressure (solid line) and pressure difference between flow paths (broken line) according to the embodiment of the disclosure;

FIG. 12 is a plan view of a flow path shape according to an embodiment of the disclosure;

FIG. 13 is a graph illustrating flow path pressure according to the embodiment of the disclosure; and

FIG. 14 is a graph illustrating oxygen partial pressure (solid line) and pressure difference between flow paths (broken line) according to the embodiment of the disclosure.

### DETAILED DESCRIPTION OF THE EMBODIMENTS

Embodiments will now be described with reference to the accompanying drawings, wherein like reference numerals designate corresponding or identical elements throughout the various drawings. Factors including, without limitation, numerical values, shapes, materials, components, positions of the components, and how the components are coupled to each other are illustrative only and not to be construed as limiting to the disclosure.

### Vehicle

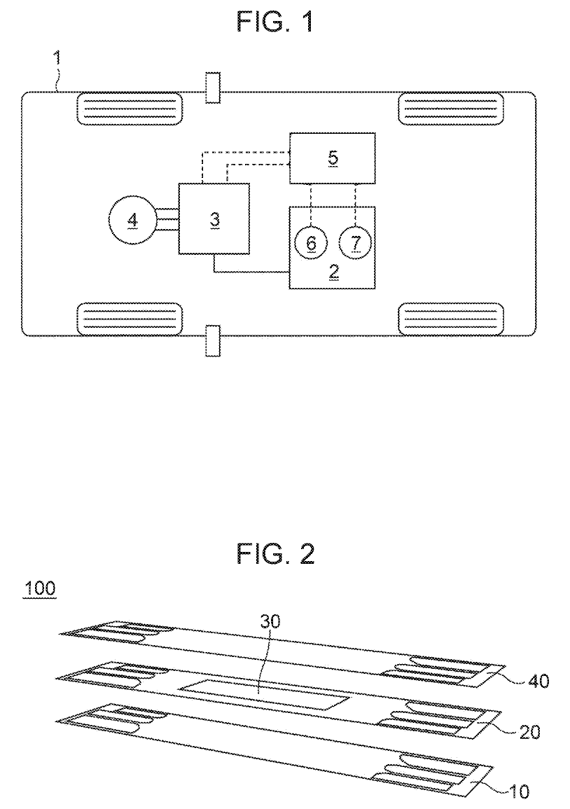

Referring to FIG. 1, a vehicle 1 according to an embodiment includes at least a fuel cell stack 2, an inverter 3, a load 4, and a control device 5. In the vehicle 1, electric power generated by the fuel cell stack 2 is supplied to the load 4 via the inverter 3 under the control by the control device 5. The vehicle 1 includes known equipment (not shown) mounted in a fuel cell vehicle, such as a hydrogen tank, an anode gas supply device, a cathode gas supply device, a coolant supply device, and a DC/DC converter.

The fuel cell stack 2 includes several tens or several hundreds of fuel cells 100 (described below) that are stacked in a stacking direction. Each fuel cell 100 has the function of generating electric power by causing an anode gas and a cathode gas to react. The fuel cell stack 2 may include a known voltage sensor 6 that can measure a voltage and the like applied to the fuel cell 100. The fuel cell stack 2 may include an electric current sensor 7 that can measure an electric current flowing through the fuel cell 100. The fuel cell 100 is not particularly limited and may be, for example, a known polymer electrolyte fuel cell (PEFC) or the like.

The inverter 3 has, for example, the function of converting direct current electric power, which is obtained by boosting voltage by using a DC/DC converter, into alternating-current electric power that is suitable for driving the load 4. The inverter 3 is not particularly limited as long as the inverter 3 has the function described above, and, for example, it is possible to use a known inverter including a three-phase bridge circuit.

The load 4 includes, for example, an electric motor that can output motive power for driving the driving wheels of the vehicle 1. The electric motor is, for example, a known three-phase alternating current electric motor. The load 4 may be another electric device mounted in the vehicle 1.

The control device 5 is a known electronic control unit (ECU) mounted in a fuel cell vehicle. The control device 5 includes one or more processors, such as a central processing unit (CPU), and one or more memories, such as a semiconductor memory, a magnetic memory, or an optical memory. The control device 5 may further include a known battery management unit (BMU) that monitors and controls the state of a battery. The control device 5 may be configured to be capable of communicating with another known ECU and various sensors (not shown) mounted in the vehicle 1.

### Fuel Cell

Referring to FIG. 2 to FIG. 5, the overall configuration of the fuel cell 100 that can be used in the fuel cell stack 2 included in the vehicle 1 will be briefly described.

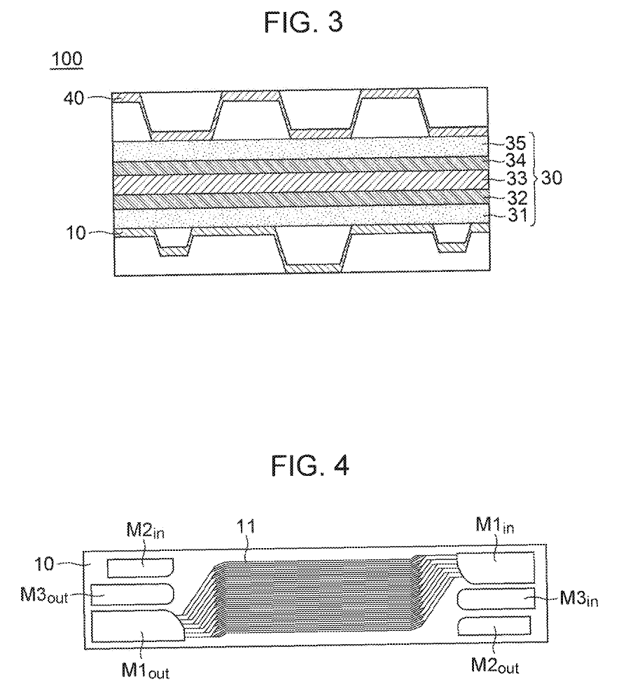

As illustrated in FIG. 2 and FIG. 3, in the fuel cell 100, at least a cathode separator 10, an MEA gasket 20, an MEA 30, and an anode separator 40 are stacked. The fuel cell 100 may further include a known or any appropriate gasket or the like in addition to the cathode separator 10, the MEA gasket 20, the MEA 30, and the anode separator 40.

### Cathode Separator

The cathode separator 10 has an embossed structure for forming flow paths through which a cathode gas flows and flow paths through which a coolant flows. A cathode gas flows on a side of the cathode separator 10 facing the MEA 30, and a coolant flows on a side of the cathode separator 10 facing away from the MEA 30.

In the example illustrated in FIG. 4, the cathode separator 10 has a cathode gas inlet M1ᵢₙ for allowing a cathode gas to flow into the fuel cell 100 and a cathode gas outlet M1ₒᵤₜ for allowing the cathode gas to flow out from the fuel cell 100, for example, adjacent to opposing short sides of the cathode separator 10 in such a way as to be diagonal. Flow paths 11, through which the cathode gas flows, connect the cathode gas inlet M1ᵢₙ to the cathode gas outlet M1ₒᵤₜ.

In addition, the cathode separator 10 has an anode gas inlet M2ᵢₙ for allowing an anode gas to flow into the fuel cell 100 and an anode gas outlet M2ₒᵤₜfor allowing the anode gas to flow out from the fuel cell 100, for example, adjacent to the opposing short sides of the cathode separator 10 in such a way as to be diagonal. Moreover, the cathode separator 10 has a coolant inlet M3ᵢₙfor allowing a coolant to flow into the fuel cell 100 and a coolant outlet M3ₒᵤₜ for allowing the coolant to flow out from the fuel cell 100, for example, adjacent to the opposing short sides of the cathode separator 10.

When the cathode separator 10 is a metal-based separator, the cathode separator 10 can be formed by performing known or any appropriate metal working, pressing, etching, or the like on a metal-based material. When the cathode separator 10 is a carbon-based separator, the cathode separator 10 can be formed by performing known or any appropriate molding, cutting, or the like on a carbon-based material. However, the material and the method of manufacturing the cathode separator 10 in the disclosure are not limited to these.

### MEA Gasket

The MEA gasket 20 has an outer shape corresponding to the cathode separator 10. The MEA gasket 20 has a cathode gas inlet, a cathode gas outlet, an anode gas inlet, an anode gas outlet, a coolant inlet, and a coolant outlet, for example, in correspondence with the cathode separator 10. A central portion of the MEA gasket 20 has an accommodation space in which the MEA 30 is disposed. The term "MEA" is an abbreviation of "membrane electrode assembly".

Examples of the material of the MEA gasket 20 include synthetic resins such as polyethylene naphthalate (PEN), polyethylene terephthalate (PET), and polyphenylene sulfide (PPS), but the disclosure is not limited to these.

### MEA

As described above, The MEA 30 is disposed in the accommodation space in the MEA gasket 20. As illustrated in FIG. 3, the MEA 30 includes, for example, a gas diffusion layer 31, a catalyst layer 32, an electrolyte membrane 33, a catalyst layer 34, and a gas diffusion layer 35 that are stacked in this order. As the materials of the MEA 30, materials of known or any appropriate MEAs can be used.

### Anode Separator

The anode separator 40 has an embossed structure for forming flow paths through which an anode gas flows and flow paths through which a coolant flows. An anode gas flows on a side of the anode separator 40 facing the MEA 30, and a coolant flows on a side of the anode separator 40 facing away from the MEA 30.

The anode separator 40 has an outer shape corresponding to the cathode separator 10 and the MEA gasket 20. The anode separator 40 has a cathode gas inlet, a cathode gas outlet, an anode gas inlet, an anode gas outlet, a coolant inlet, and a coolant outlet, for example, in correspondence with the cathode separator 10 and the MEA gasket 20.

When the anode separator 40 is a metal-based separator, the anode separator 40 can be formed by performing known or any appropriate metal working, pressing, etching, or the like on a metal-based material. When the anode separator 40 is a carbon-based separator, the anode separator 40 can be formed by performing known or any appropriate molding, cutting, or the like on a carbon-based material. However, the material and the method of manufacturing the anode separator 40 in the disclosure are not limited to these.

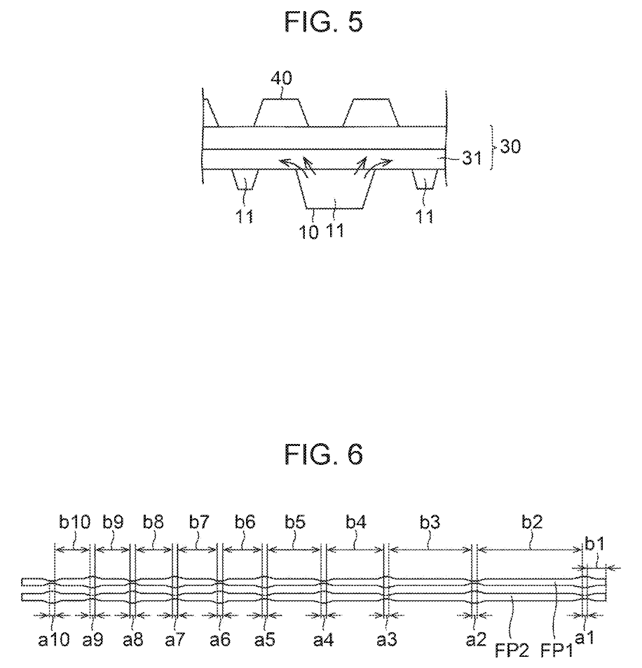

Heretofore, the overall configuration of the fuel cell 100 has been briefly described. In the fuel cell 100, for example, as indicated by the arrows in FIG. 5, due to a pressure difference between the adjacent flow paths 11 of the cathode separator 10, underflow between the flow paths 11 is generated in the gas diffusion layer 31.

### Comparative Example

Referring to FIG. 6 to FIG. 8, a cathode separator according to a comparative example will be described before describing the cathode separator 10 or the anode separator 40 for which a separator according to the disclosure can be used.

Referring to FIG. 6, a cathode separator according to the comparative example includes a first flow path FP1 and a second flow path FP2 that are adjacent to each other. Here, the cathode separator according to the comparative example includes narrow-width portions for accelerating diffusion of a cathode gas between the first flow path FP1 and the second flow path FP2. For example, in the first flow path FP1, wide-width portions in which the groove width is partially wide and narrow-width portions in which the groove width is partially narrow are alternately repeated from the inlet toward the outlet of the first flow path FP1. In the second flow path FP2, narrow-width portions that are adjacent to the wide-width portions of the first flow path FP1 and in which the groove width is partially narrow and wide-width portions that are adjacent to the narrow-width portions of the first flow path FP1 and in which the groove width is partially wide are alternately repeated from the inlet toward the outlet of the second flow path FP2. In FIG. 6, the narrow-width portions and the wide-width portions respectively have the same shapes. Hereafter, in the comparative example, sections that include the narrow-width portions or wide-width portions will be referred to as first sections a1, a2, ... , a10 and sections that do not include the narrow-width portions or the wide-width portions will be referred to as second sections b1, b2, ... , b10.

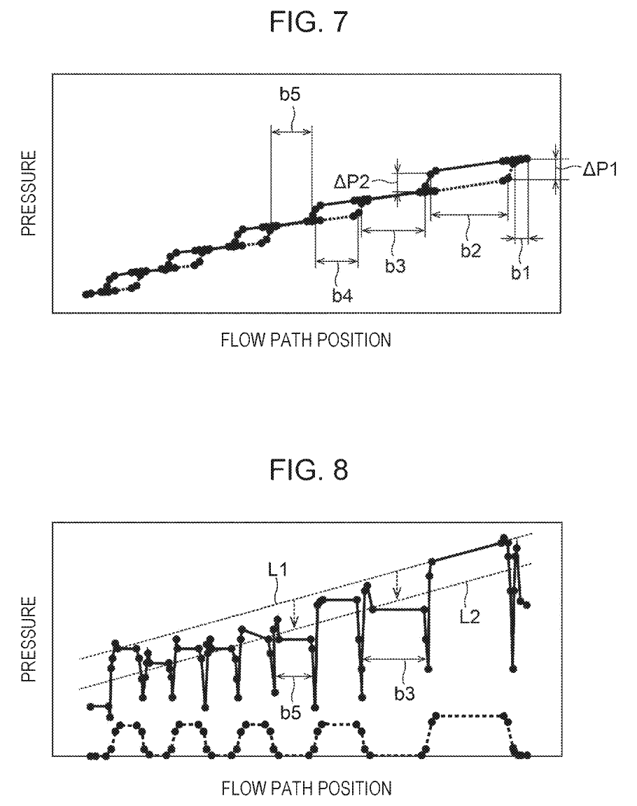

In the cathode separator according to the comparative example, narrow-width portions having the same shape are alternately repeated. Therefore, as illustrated in FIG. 7, a pressure loss ΔP₁ applied to a cathode gas in the second flow path FP2 by a narrow-width portion of first section a1 and a pressure loss ΔP₂ applied to a cathode gas in the first flow path FP1 by a narrow-width portion of the first section a2 are substantially the same. Because the pressure loss ΔP₁ and the pressure loss ΔP₂ are substantially the same, as indicated by the broken line in FIG. 8, there is substantially no pressure difference between the first flow path FP1 and the second flow path FP2 in the second section b3. For the same reason, there is substantially no pressure difference between the first flow path FP1 and the second flow path FP2 in the second section b5 and the like. In FIG. 7, "flow path position" means the coordinate position from the inlet from the flow path, the right side in the plane of figure is the inlet side of the flow path, and the left side in the plane of figure is the outlet side of the flow path. Hereafter, the definition of "flow path position" is the same as this.

Here, as indicated by the solid line in FIG. 8, the oxygen partial pressure in a region of the gas diffusion layer of the MEA corresponding to the space between the first flow path FP1 and the second flow path FP2 (hereafter, referred to as "under-rib oxygen partial pressure") has a tendency of decreasing from the inlet toward the outlet of the flow path. When there is substantially no pressure difference as described above, the effect of diffusion of a cathode gas toward an adjacent flow path and toward the gas diffusion layer is weak. Therefore, for example, although it is desirable that the oxygen partial pressures in the second section b3 and the second section b5 be on a straight line L1, in reality, the oxygen partial pressure decreases along a straight line L2, which is lower than the oxygen partial pressure represented by the straight line L1, and this leads to decrease in diffusion of the cathode gas. Thus, it is desirable to improve diffusion of a reactant gas by reducing, as much as possible, regions in which the pressure difference between the first flow path FP1 and the second flow path FP2 is small as in the comparative example.

### First Embodiment

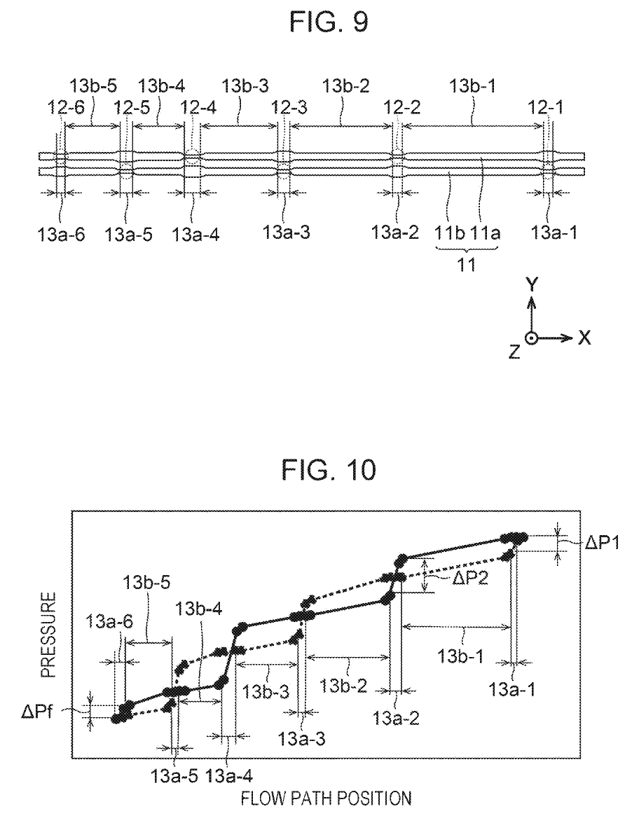

Referring to FIG. 9 to FIG. 11, a cathode separator 10 (hereafter, referred to as "separator 10") according to a first embodiment of the disclosure will be described in detail.

Referring to FIG. 9, the separator 10 includes a flow path 11 at least including a first flow path 11a and a second flow path 11b that are adjacent to each other. In each of the first flow path 11a and the second flow path 11b, a reactant gas flows from the positive direction toward the negative direction along the X axis. As can be seen by also referring to FIG. 3, a coolant flows between the first flow path 11a and the second flow path 11b. The reactant gas is a cathode gas in the present embodiment, but the disclosure is not limited to this. That is, the reactant gas may be an anode gas, when a structure that is the same as the structure of the first flow path 11a and the second flow path 11b is used for the anode separator 40. Accordingly, it is possible to use a separator according to the embodiment also as the anode separator 40.

In the example illustrated in FIG. 9, from the inlet toward the outlet of the flow path 11, (i) a first section 13a-1 of the second flow path 11b includes a pressure loss applier 12-1, (ii) a first section 13a-2 of the first flow path 11a includes a pressure loss applier 12-2, (iii) a first section 13a-3 of the second flow path 11b includes a pressure loss applier 12-3, (iv) a first section 13a-4 of the first flow path 11a includes a pressure loss applier 12-4, (v) a first section 13a-5 of the second flow path 11b includes a pressure loss applier 12-5, and (vi) a first section 13a-6 of the first flow path 11a includes a pressure loss applier 12-6. Moreover, from the inlet toward the outlet of the flow path 11, (i) a second section 13b-1 is disposed between the first section 13a-1 and the first section 13a-2, (ii) a second section 13b-2 is disposed between the first section 13a-2 and the first section 13a-3, (iii) a second section 13b-3 is disposed between the first section 13a-3 and the first section 13a-4, (iv) a second section 13b-4 is disposed between the first section 13a-4 and the first section 13a-5, and (v) a second section 13b-5 is disposed between the first section 13a-5 and the first section 13a-6. Hereafter, the pressure loss appliers 12-1, 12-2, 12-3, 12-4, 12-5, and 12-6 may be collectively referred to as "pressure loss applier 12"; the first sections 13a-1, 13a-2, 13a-3, 13a-4, 13a-5, and 13a-6 may be collectively referred to as "first section 13a"; and the second sections 13b-1, 13b-2, 13b-3, 13b-4, and 13b-5 may be collectively referred to as "second section 13b". However, the numbers of the pressure loss appliers 12, the first sections 13a, and the second sections 13b in the embodiment are not limited to those in the example illustrated in FIG. 9, and can be changed as appropriate in accordance with the length of the flow path 11, the pressure or the concentration of a reactant gas, and the like.

In other words, the flow path 11 includes at least two first sections 13a each including the pressure loss applier 12 that applies a pressure loss to a reactant gas that flows in the first flow path 11a or the second flow path 11b and a second section 13b interposed between the at least two first sections 13a. Here, in the first embodiment, the pressure loss applier 12 reverses the magnitude relationship between the pressure in the first flow path 11a and the pressure in the second flow path 11b before and after the reactant gas passes through the first section 13a.

FIG. 10 illustrates the pressure in the flow path 11 of the separator 10 illustrated in FIG. 9, the solid line indicates the pressure in the first flow path 11a, and the broken line indicates the pressure in the second flow path 11b. In the example illustrated in FIG. 10, in the second section 13b-1, in which a cathode gas before passing through the first section 13a-2 flows, the pressure in the first flow path 11a is greater than the pressure in the second flow path 11b. On the other hand, in the second section 13b-2, in which the cathode gas after passing through the first section 13a-2 flows, the pressure in the first flow path 11a is less than the pressure in the second flow path 11b.

In the second section 13b-2, in which the cathode gas before passing through the first section 13a-3 flows, the pressure in the second flow path 11b is greater than the pressure in the first flow path 11a. On the other hand, in the second section 13b-3, in which the cathode gas after passing through the first section 13a-3 flows, the pressure in the second flow path 11b is less than the pressure in the first flow path 11a.

In the second section 13b-3, in which the cathode gas before passing through the first section 13a-4 flows, the pressure in the first flow path 11a is greater than the pressure in the second flow path 11b. On the other hand, in the second section 13b-4, in which the cathode gas after passing through the first section 13a-4 flows, the pressure in the first flow path 11a is less than the pressure in the second flow path 11b.

In the second section 13b-4, in which the cathode gas before passing through the first section 13a-5 flows, the pressure in the second flow path 11b is greater than the pressure in the first flow path 11a. On the other hand, in the second section 13b-5, in which the cathode gas after passing through the first section 13a-5 flows, the pressure in the second flow path 11b is less than the pressure in the first flow path 11a.

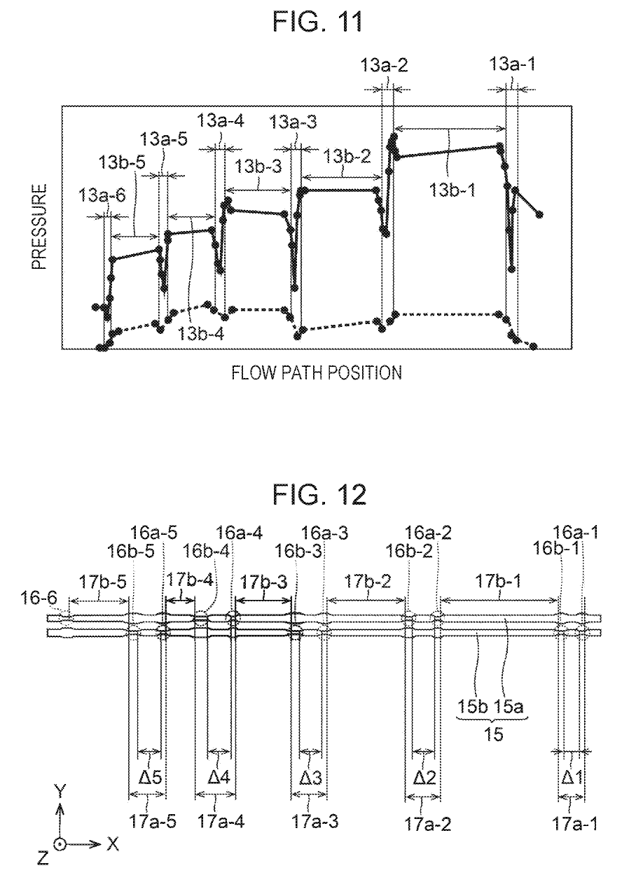

Thus, as indicated by the solid line in FIG. 11, it is possible to maintain high under-rib oxygen partial pressure in the second section 13b, which does not include the pressure loss applier 12. Therefore, it is possible to minimize decrease in oxygen partial pressure also in the first section 13a, and, as a result, an advantageous effect of improving diffusion of the cathode gas, corresponding to a reactant gas, between the first flow path 11a and the second flow path 11b is obtained.

In view of improving diffusion of a reactant gas, the pressure loss applier 12 may adjust, in the following way, the pressure difference in a flow path that is either the first flow path 11a or the second flow path 11b and that includes the pressure loss applier 12 before and after the reactant gas passes through the first section 13a. That is, the pressure loss applier 12 may adjust the pressure difference to be greater than the pressure difference between the pressure in the first flow path 11a and the pressure in the second flow path 11b before the reactant gas passes through the first section 13a.

In the example illustrated in FIG. 10, the pressure loss ΔP₂ applied by the pressure loss applier 12-2 of the first section 13a-2, which is the second from the inlet of the flow path 11, is greater than the pressure loss ΔP₁ applied by the pressure loss applier 12-1 of the first section 13a-1, which is the first from the inlet of the flow path 11. Thus, the pressure difference in the first flow path 11a before and after a reactant gas passes through the first section 13a-2 is greater than the pressure difference between the first flow path 11a and the second flow path 11b in the second section 13b-1. As a result, it is possible to reverse the magnitude relationship between the pressure in the first flow path 11a and the pressure in the second flow path 11b before and after the reactant gas passes through the first section 13a-2. The magnitude relationship between the pressures before and after the reactant gas passes through the first sections 13a-3, 13a-4, and 13a-5 can be considered in the same way as this.

ΔPᵢ denotes the pressure loss applied by the pressure loss applier 12-i, which is the i-th from the inlet of the flow path 11, and Δpᵢ denotes the pressure difference between the first flow path 11a and the second flow path 11b in the second section 13b-i, which is the i-th from the inlet of the flow path 11, where i is a natural number greater than or equal to 2. ΔP₁ is a pressure loss applied by the pressure loss applier 12-1, which is the first from the inlet of the flow path 11, and Δp₁ is the pressure difference between the first flow path 11a and the second flow path 11b in the second section 13b-1, which is the first from the inlet of the flow path 11. Then, in the present embodiment, a relationship Δpᵢ = ΔPᵢ - Δpᵢ₋₁ approximately holds, and it is possible to improve diffusion of a reactant gas by making ΔPᵢ greater than Δpᵢ₋₁.

That is, when ΔPᵢ/Δpᵢ₋₁ > 1 is satisfied, a pressure difference is generated between the flow paths 11. Preferably, ΔPᵢ/Δpᵢ₋₁ > 2 is satisfied in order to keep a certain pressure difference between the flow paths 11. The upper limit value of ΔPᵢ/Δpᵢ₋₁ is not particularly limited in obtaining the main advantageous effect of the present embodiment. However, if ΔPᵢ is excessively greater than Δpᵢ₋₁, the pressure loss in the entirety of the flow path 11 increases, and the pressure at the inlet of the flow path 11 needs to be high. Then, over-drying may occur on the inlet side of the flow path 11, and the performance of the fuel cell may decrease. Thus, the pressure loss in the entirety of the flow path 11 is preferably adjusted by adjusting the number of the pressure loss appliers 12 so that the upper value of pressure at the inlet of the flow path 11, which is set in view of suppression of over-drying, will not be exceeded. The pressure and the concentration of the reactant gas decrease from the inlet toward the outlet of the flow path 11. Therefore, ΔPᵢ/Δpᵢ₋₁ is preferably increased from the inlet toward the outlet of the flow path 11. When a large-diameter portion described below is present, because decrease in the pressure of the reactant gas in a flow path including the large-diameter portion is alleviated, ΔPᵢ is defined as a value in which the alleviated amount of pressure difference is taken into consideration.

The second section 13b may include second sections 13b whose lengths in the extension direction of the flow path 11 gradually decrease from the inlet toward the outlet of the flow path 11. Thus, because the pressure and the concentration of the reactant gas tend to decrease from the inlet toward the outlet of the flow path 11, it is possible to dispose a larger number of pressure loss appliers 12 with increasing distance from the inlet toward the outlet of the flow path 11. As a result, it is possible to further improve diffusion of a reactant gas. In the example illustrated in FIG. 9, the length of the second section 13b-1 in the X direction between the first section 13a-1, which is the first from the inlet of the flow path 11, and the first section 13a-2, which is the second from the inlet of the flow path 11, is the longest. The lengths of the second section 13b-2, the second section 13b-3, the second section 13b-4, and the second section 13b-5 in the X direction gradually decrease in this order.

Here, an example of the structure of the pressure loss applier 12 will be described. The pressure loss applier 12 may include a small-diameter portion whose flow-path cross-sectional area is smaller than that of the second section 13b. In the example illustrated in FIG. 9, in each of the first section 13a-2, the first section 13a-4, and the first section 13a-6, the first flow path 11a includes a small-diameter portion in which at least one of the widths in the Y direction and the depth in the Z direction is partially small. Moreover, in each of the first section 13a-1, the first section 13a-3, and the first section 13a-5, the second flow path 11b includes a small-diameter portion in which at least one of the widths in the Y direction and the depth in the Z direction is partially small.

It is possible to adjust the flow-path cross-sectional area of the small-diameter portion by appropriately adjusting at least one of the width in the Y direction and the depth in the Z direction so that the magnitude relationship of pressure is reversed in consideration of the flow rate of the reactant gas and the like. For the same reason, it is possible to appropriately adjust the length of the small-diameter portion in the X direction so that the magnitude relationship of pressure is reversed in consideration of the flow rate of the reactant gas and the like. The Z direction is the stacking direction of the fuel cells 100.

When the pressure loss applier 12 includes a small-diameter portion, in the first section 13a, a flow path that is either the first flow path 11a or the second flow path 11b and that does not include the pressure loss applier 12 may include a large-diameter portion whose flow-path cross-sectional area is greater than that of the second section 13b. Thus, it is possible to maintain the distance between the first flow path 11a and the second flow path 11b in the first section 13a and the distance between the first flow path 11a and the second flow path 11b in the second section 13b to be uniform or substantially uniform. Therefore, it is possible to maintain the diffusion distance of the reactant gas to be uniform or substantially uniform.

In the example illustrated in FIG. 9, in each of the first section 13a-2, the first section 13a-4, and the first section 13a-6, the second flow path 11b includes a large-diameter portion in which at least one of the widths in the Y direction and the depth in the Z direction is partially large. This large-diameter portion is adjacent to the small-diameter portion of the first flow path 11a in the Y direction and has a shape along the shape of the small-diameter portion in the X direction. Moreover, in each of the first section 13a-1, the first section 13a-3, and the first section 13a-5, the first flow path 11a includes a large-diameter portion in which at least one of the widths in the Y direction and the depth in the Z direction is partially large. This large-diameter portion is also adjacent to the small-diameter portion of the second flow path 11b in the Y direction and has a shape along the shape of the small-diameter portion in the X direction. It is possible to appropriately adjust the length of the large-diameter portion in the X direction in accordance with the length of the small-diameter portion in the X direction so that the shape of the large-diameter portion is along the shape of the small-diameter portion.

However, as long as it is possible to reverse the magnitude relationship of pressure, the pressure loss applier 12 is not limited to the small-diameter portion described above. For example, the pressure loss applier 12 may be included, instead of in the small-diameter portion and the large-diameter portion described above, in a region of the first flow path 11a and the second flow path 11b corresponding to the small-diameter portion and may be composed of a partition wall, a projection, or the like for reducing the flow-path cross-sectional area. For example, the pressure loss applier 12 may be composed of, instead of the small-diameter portion and the large-diameter portion described above, a mesh filter or the like disposed in a region of the first flow path 11a and the second flow path 11b corresponding to the small-diameter portion.

As heretofore described, with the separator 10 according to the first embodiment, the pressure loss applier 12 reverses the magnitude relationship between the pressure in the first flow path 11a and the pressure in the second flow path 11b before and after a reactant gas passes through the first section 13a. Thus, it is possible to maintain high under-rib oxygen partial pressure in the second section 13b. Therefore, it is possible to minimize decrease of the partial pressure of the reactant gas also in the first section 13a, and, as a result, it is possible improve diffusion of the reactant gas between the first flow path 11a and the second flow path 11b. Accordingly, it is possible to improve gas diffusion between adjacent gas flow paths in the separator 10.

In view of reducing the flow rate difference of the reactant gas between the first flow path 11a and the second flow path 11b, the pressure loss applier 12 in proximity to the outlet of the flow path 11 may be included in a flow path that is either the first flow path 11a or the second flow path 11b and in which the pressure is higher before the reactant gas passes through the pressure loss applier 12. In this case, the pressure loss applier 12 in proximity to the outlet of the flow path 11 is configured to cause the pressure difference between the first flow path 11a and the second flow path 11b after the reactant gas has passed through the pressure loss applier 12 to be less than a threshold.

In the example illustrated in FIG. 9 and FIG. 10, the pressure in the pressure loss applier 12-6, which is the first from the outlet of the flow path 11 (that is, the sixth from the inlet of the flow path 11), before the reactant gas passes through the pressure loss applier 12-6 is higher in the first flow path 11a than in the second flow path 11b. Therefore, the pressure loss applier 12-6, which is the first from the outlet of the flow path 11, is included in the first flow path 11a. The pressure loss applier 12-6 applies a pressure loss ΔP_{f} to the reactant gas flowing in the first flow path 11a so that the pressure difference between the first flow path 11a and the second flow path 11b after the reactant gas has passed through the pressure loss applier 12-6 becomes less than a threshold. The threshold is, for example, 0kPa. However, the disclosure is not limited to this, and it is possible to appropriately adjust the threshold in view of reducing the flow rate difference of the reactant gas between the first flow path 11a and the second flow path 11b.

### Second Embodiment

Referring to FIG. 12 to FIG. 14, a cathode separator 10 (hereafter, referred to as "separator 10") according to a second embodiment of the disclosure will be described in detail. Points that are different from those of the first embodiment will be mainly described, and descriptions in the first embodiment apply to the other points.

Referring to FIG. 12, the separator 10 includes a flow path 15 at least including a first flow path 15a and a second flow path 15b that are adjacent to each other. In each of the first flow path 15a and the second flow path 15b, a reactant gas flows from the positive direction toward the negative direction along the X axis. As can be seen by also referring to FIG. 3, a coolant flows between the first flow path 15a and the second flow path 15b. The reactant gas is a cathode gas in the present embodiment, but the disclosure is not limited to this. That is, the reactant gas may be an anode gas, when a structure that is the same as the structure of the first flow path 15a and the second flow path 15b is used for the anode separator 40. Accordingly, it is possible to use a separator according to the embodiment also as the anode separator 40.

In the example illustrated in FIG. 12, from the inlet toward the outlet of the flow path 15, (i) a first section 17a-1 of the second flow path 15b includes a first pressure loss applier 16a-1 and a second pressure loss applier 16b-1 with a predetermined distance Δ1 therebetween, (ii) a first section 17a-2 of the first flow path 15a incudes a first pressure loss applier 16a-2 and a second pressure loss applier 16b-2 with a predetermined distance Δ2 therebetween, (iii) a first section 17a-3 of the second flow path 15b includes a first pressure loss applier 16a-3 and a second pressure loss applier 16b-3 with a predetermined distance Δ3 therebetween, (iv) a first section 17a-4 of the first flow path 15a includes a first pressure loss applier 16a-4 and a second pressure loss applier 16b-4 with a predetermined distance Δ4 therebetween, and (v) a first section 17a-5 of the second flow path 15b includes a first pressure loss applier 16a-5 and a second pressure loss applier 16b-5 with a predetermined distance Δ5 therebetween. As describe below in detail, a pressure loss applier 16-6 is disposed closer than second pressure loss applier 16b-5 to the outlet of the first flow path 15a.

Moreover, in the example illustrated in FIG. 12, from the inlet toward the outlet of the flow path 15, (i) a second section 17b-1 is disposed between the first section 17a-1 and the first section 17a-2, (ii) a second section 17b-2 is disposed between the first section 17a-2 and the first section 17a-3, (iii) a second section 17b-3 is disposed between the first section 17a-3 and the first section 17a-4, (iv) a second section 17b-4 is disposed between the first section 17a-4 and the first section 17a-5, and (v) a second section 17b-5 is disposed between the first section 17a-5 and the first section 17a-6.

Hereafter, the first pressure loss appliers 16a-1, 16a-2, 16a-3, 16a-4, and 16a-5 may be collectively referred to as "first pressure loss applier 16a", and the second pressure loss appliers 16b-1, 16b-2, 16b-3, 16b-4, and 16b-5 may be collectively referred to as "second pressure loss applier 16b". The first pressure loss applier 16a and the second pressure loss applier 16b may be collectively referred to as "pressure loss applier 16". The predetermined distances Δ1, Δ2, Δ3, Δ4, and Δ5 may be collectively referred to as "predetermined distance Δ". The first sections 17a-1, 17a-2, 17a-3, 17a-4, and 17a-5 may be collectively referred to as "first section 17a", and the second sections 17b-1, 17b-2, 17b-3, 17b-4, and 17b-5 may be collectively referred to as "second section 17b". However, the numbers of the pressure loss appliers 16, the first sections 17a, and the second sections 17b in the embodiment are not limited to those in the example illustrated in FIG. 12, and can be changed as appropriate in accordance with the length of the flow path 15, the pressure or the concentration of a reactant gas, and the like.

In other words, the flow path 15 includes at least two first sections 17a each including the pressure loss applier 16 that applies a pressure loss to a reactant gas that flows in the first flow path 15a or the second flow path 15b and a second section 17b interposed between the at least two first sections 17a. The pressure loss applier 16 includes the first pressure loss applier 16a and the second pressure loss applier 16b. The second pressure loss applier 16b is disposed on the downstream side, in the flow of a reactant gas, of the first pressure loss applier 16a with a predetermined distance Δ therebetween. Here, in the second embodiment, one of the first pressure loss applier 16a and the second pressure loss applier 16b reverses the magnitude relationship between the pressure in the first flow path 15a and the pressure in the second flow path 15b.

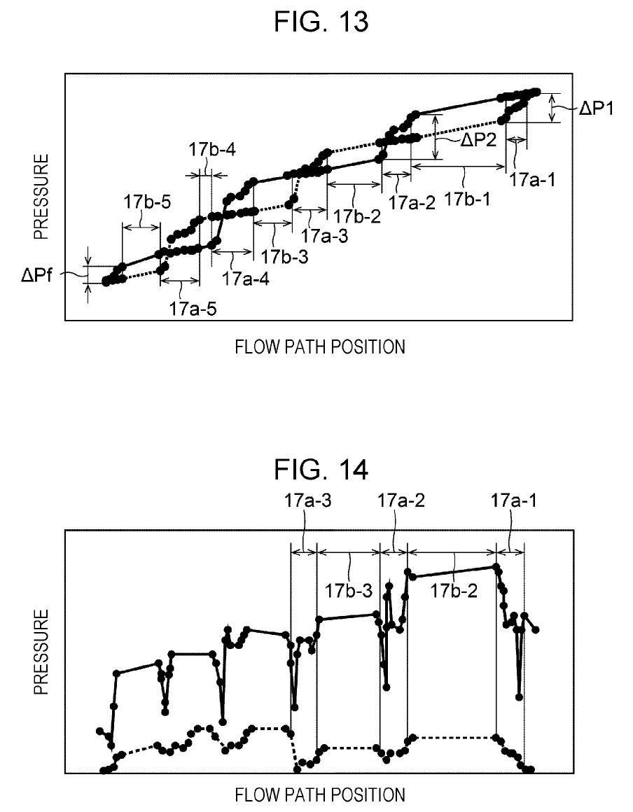

FIG. 13 illustrates the pressure in the flow path 15 of the separator 10 illustrated in FIG. 12, the solid line indicates the pressure in the first flow path 15a, and the broken line indicates the pressure in the second flow path 15b. In the example illustrated in FIG. 13, the magnitude relationship between the pressure in the first flow path 15a and the pressure in the second flow path 15b in the second section 17b is reversed before and after the first section 17a. For example, the magnitude relationship between the pressures in the first flow path 15a and the second flow path 15b is reversed, respectively, (i) in the first section 17a-2 due to the second pressure loss applier 16b-2, (ii) in the first section 17a-3 due to the second pressure loss applier 16b-3, (iii) in the first section 17a-4 due to the second pressure loss applier 16b-4, and (iv) in the first section 17a-5 due to the second pressure loss applier 16b-5.

Thus, as indicated by the solid line in FIG. 13, it is possible to maintain high under-rib oxygen partial pressure in a section of the first section 17a that does not include the second pressure loss applier 16b and in the second section 17b. Therefore, it is possible to minimize decrease in oxygen partial pressure also in a section of the first section 17a that includes the second pressure loss applier 16b, and, as a result, an advantageous effect of improving diffusion of a cathode gas, corresponding to a reactant gas, between the first flow path 15a and the second flow path 15b is obtained. Moreover, because it is possible to adjust the pressure loss in the first section 17a in two steps by using the first pressure loss applier 16a and the second pressure loss applier 16b, it is possible to finely adjust the pressure between the flow paths 15.

Moreover, in the second embodiment, the pressure loss applied by the second pressure loss applier 16b is greater than the pressure loss applied by the first pressure loss applier 16a. Thus, it is possible to suppress decrease of diffusion of a cathode gas, corresponding to a reactant gas, between the first pressure loss applier 16a and the second pressure loss applier 16b in the first section 17a.

Although not particularly limited, it is possible to realize this by, for example, adjusting the shapes of the first pressure loss applier 16a and the second pressure loss applier 16b. For example, it is possible to realize this by making the length of the second pressure loss applier 16b in the X direction be greater than that of the first pressure loss applier 16a in each of the first sections 17a. Moreover, it is possible to realize this by making at least one of the width in the Y direction and the depth in the z direction of the second pressure loss applier 16b be greater than that of the first pressure loss applier 16a in each of the first sections 17a.

In view of improving diffusion of a reactant gas, the first pressure loss applier 16a and the second pressure loss applier 16b may adjust, in the following way, the pressure difference in a flow path that is either the first flow path 15a or the second flow path 15b and that includes the first pressure loss applier 16a and the second pressure loss applier 16b before and after the reactant gas passes through the first section 17a. That is, the first pressure loss applier 16a and the second pressure loss applier 16b may adjust the pressure difference to be greater than the pressure difference between the pressure in the first flow path 15a and the pressure in the second flow path 15b before the reactant gas passes through the first section 17a.

In the example illustrated in FIG. 12 and FIG. 13, the pressure loss ΔP₂ applied by the first pressure loss applier 16a-2 and the second pressure loss applier 16b-2 of the first section 17a-2, which is the second from the inlet of the flow path 15, is greater than the pressure loss ΔP₁ applied by the first pressure loss applier 16a-1 and the second pressure loss applier 16b-1 in the first section 17a-1, which is the first from the inlet of the flow path 15. Thus, the pressure difference in the first flow path 15a before and after the reactant gas passes through the first section 17a-2 is greater than the pressure difference between the first flow path 15a and the second flow path 15b in the second section 17b-1. As a result, it is possible to reverse the magnitude relationship between the pressure in the first flow path 15a and the pressure in the second flow path 15b before and after the reactant gas passes through the first section 17a-2. The magnitude relationship between the pressures before and after the reactant gas passes through the first sections 17a-3, 17a-4, and 17a-5 can be considered in the same way as this. That is, with the second embodiment, as with the first embodiment, it is possible to improve diffusion of the reactant gas by making ΔPᵢ greater than Δpᵢ₋₁.

In view of improving diffusion of a reactant gas, as with the first embodiment, the second section 17b may include second sections 17b whose lengths in the extension direction of the flow path 15 gradually decrease from the inlet toward the outlet of the flow path 15. In the example illustrated in FIG. 12, the length of the second section 17b-1 in the X direction between the first section 17a-1, which is the first from the inlet of the flow path 15, and the first section 17a-2, which is the second from the inlet of the flow path 15, is the longest. In the example illustrated in FIG. 12, the lengths of the second section 17b-2, the second section 17b-3, the second section 17b-4, and the second section 17b-5 in the X direction gradually decrease in this order.

Here, an example of the structure of the pressure loss applier 16 will be described. As with the first embodiment, the first pressure loss applier 16a and the second pressure loss applier 16b may each include a small-diameter portion whose flow-path cross-sectional area is smaller than that of the second section 17b. In this case, as with the first embodiment, in the first section 17a, a flow path that is either the first flow path 15a or the second flow path 15b and that does not include the first pressure loss applier 16a and the second pressure loss applier 16b may include a large-diameter portion whose flow-path cross-sectional area is greater than that of the second section 17b. However, the disclosure is not limited this, and, as with the first embodiment, the first pressure loss applier 16a and the second pressure loss applier 16b may be composed of a partition wall, a projection, or the like, or may be composed of a mesh filter or the like.

As heretofore described, in the separator 10 according to the second embodiment, the pressure loss applier 16 includes the first pressure loss applier 16a and the second pressure loss applier 16b. Moreover, the pressure loss applied by the second pressure loss applier 16b is greater than the pressure loss applied by the first pressure loss applier 16a. Moreover, one of the first pressure loss applier 16a and the second pressure loss applier 16b reverses the magnitude relationship between the pressure in the first flow path 15a and the pressure in the second flow path 15b.

Thus, it is possible to maintain high under-rib oxygen partial pressure in a section of the first section 17a that does not include the second pressure loss applier 16b and in the second section 17b. Therefore, it is possible to minimize decrease in oxygen partial pressure also in a section of the first section 17a that includes the second pressure loss applier 16b, and, as a result, it is possible to improve diffusion of a cathode gas, corresponding to a reactant gas, between the first flow path 15a and the second flow path 15b. That is, as with the first embodiment, it is possible to improve gas diffusion between adjacent gas flow paths in the separator 10. Moreover, with the second embodiment, because it is possible to adjust the pressure loss in the first section 17a in two steps by using the first pressure loss applier 16a and the second pressure loss applier 16b, it is possible to more finely adjust the pressure between the flow paths in the separator 10 than with the first embodiment.

As with the first embodiment, the pressure loss applier 16 in proximity to the outlet of the flow path 15 may be included in a flow path that is either the first flow path 15a or the second flow path 15b and in which the pressure is higher before a reactant gas passes through the pressure loss applier 16. In this case, the pressure loss applier 16 causes the pressure difference between the first flow path 15a and the second flow path 15b after the reactant gas has passed through the pressure loss applier 16 to be less than a threshold.

In the example illustrated in FIG. 12 and FIG. 13, the pressure in the pressure loss applier 16-6, which is the first from the outlet of the flow path 15 (that is, the sixth from the inlet of the flow path 15), before the reactant gas passes through the pressure loss applier 16-6 is higher in the first flow path 15a than in the second flow path 15b. Therefore, the pressure loss applier 16-6, which is the first from the outlet of the flow path 15, is included in the first flow path 15a. The pressure loss applier 16-6 applies a pressure loss ΔP_{f} to the reactant gas flowing in the first flow path 15a so that the pressure difference between the first flow path 15a and the second flow path 15b after the reactant gas has passed through the pressure loss applier 16-6 becomes less than a threshold. The threshold is, for example, 0kPa. However, the disclosure is not limited to this, and it is possible to appropriately adjust the threshold in view of reducing the flow rate difference of the reactant gas between the first flow path 15a and the second flow path 15b.

According to the first embodiment or the second embodiment, it is possible to realize the technique of the disclosure as the fuel cell 100 including the separator 10 or the separator 40. Moreover, it is possible to realize the technique of the disclosure as the vehicle 1 including the fuel cell 100.

With embodiments according to the disclosure, it is possible to improve diffusion of a reactant gas between adjacent flow paths of a separator.

To date, various improvements have been made on a gas flow path in order to increase the power generation performance of a fuel cell.

For example, Japanese Unexamined Patent Application Publication (JP-A) No. 2021-163663 describes a gas flow path structure including groove-shaped gas flow paths in a surface of at least one support plate that is disposed adjacent to at least one gas diffusion layer of two gas diffusion layers of two electrodes of a membrane electrode assembly, the surface being in contact with the gas diffusion layer, the membrane electrode assembly including the two electrodes, including two catalyst layers and the two gas diffusion layers, and an electrolyte membrane disposed between the two catalyst layers. For example, JP-A No. 2021-163663 describes the following: each of the gas flow paths includes, in the same gas flow path, two or more first regions and two or more second regions whose flow-path cross-sectional area is smaller than that of the first regions; the first regions and the second regions are alternately disposed in the same gas flow path; regarding the gas flow path, each first region and each second region are alternately disposed between the gas flow paths that are adjacent to each other; and the gas flow path includes, in each second region, at least one third region whose flow-path cross-sectional area is smaller than that of the second region. The entire contents of this publication are incorporated herein by reference.

A flow path in which first regions (wide grooves) and second regions (narrow grooves) are alternately repeated as in the technique described in JP-A No. 2021-163663 has a problem in that diffusion of a reactant gas decreases between adjacent flow paths of a separator.

It is desirable to provide a technique for improving diffusion of a reactant gas between adjacent flow paths of a separator.

Obviously, numerous modifications and variations of the present invention are possible in light of the above teachings. It is therefore to be understood that within the scope of the appended claims, the invention may be practiced otherwise than as specifically described herein.

1. A separator, comprising:
a flow path comprising a first flow path and a second flow path that are adjacent to each other,
wherein the flow path comprises a plurality of first sections each comprising a pressure loss applier configured to apply a pressure loss to a reactant gas in at least one of the first flow path and the second flow path, and a second section interposed between the first sections, and the pressure loss applier is configured to reverse a magnitude relationship between a pressure in the first flow path and a pressure in the second flow path before and after the reactant gas passes through the first section.

2. The separator according to claim 1, wherein the pressure loss applier is configured to cause a pressure difference in one of the first flow path and the second flow path which comprises the pressure loss applier before and after the reactant gas passes through the first section to be greater than a pressure difference between the pressure in the first flow path and the pressure in the second flow path before the reactant gas passes through the first section.

3. The separator according to claim 1, wherein the pressure loss applier comprises a first pressure loss applier and a second pressure loss applier positioned on a downstream side, in a flow of the reactant gas, of the first pressure loss applier with a predetermined distance therebetween, a pressure loss to be applied by the second pressure loss applier is greater than a pressure loss to be applied by the first pressure loss applier, and one of the first pressure loss applier and the second pressure loss applier is configured to reverse the magnitude relationship between the pressure in the first flow path and the pressure in the second flow path.

4. The separator according to claim 2, the pressure loss applier comprises a first pressure loss applier and a second pressure loss applier positioned on a downstream side, in a flow of the reactant gas, of the first pressure loss applier with a predetermined distance therebetween, a pressure loss to be applied by the second pressure loss applier is greater than a pressure loss to be applied by the first pressure loss applier, and one of the first pressure loss applier and the second pressure loss applier is configured to reverse the magnitude relationship between the pressure in the first flow path and the pressure in the second flow path.

5. The separator according to claim 1, wherein the pressure loss applier in proximity to an outlet of the flow path is comprised in a flow path that is one of the first flow path and the second flow path and in which a pressure is higher before the reactant gas passes through the pressure loss applier, and cause a pressure difference between the first flow path and the second flow path after the reactant gas has passed through the pressure loss applier to be less than a threshold.

6. The separator according to claim 2, wherein the pressure loss applier in proximity to an outlet of the flow path is comprised in a flow path that is one of the first flow path and the second flow path and in which a pressure is higher before the reactant gas passes through the pressure loss applier, and cause a pressure difference between the first flow path and the second flow path after the reactant gas has passed through the pressure loss applier to be less than a threshold.

7. The separator according to claim 1, wherein the second section comprises second sections whose lengths in an extension direction of the flow path gradually decrease from an inlet of the flow path toward an outlet of the flow path.

8. The separator according to claim 2, wherein the second section comprises second sections whose lengths in an extension direction of the flow path gradually decrease from an inlet of the flow path toward an outlet of the flow path.
